(19) United States
(12) Patent Application Publication
(10) Pub. No.: US 2021/0397382 A1
(43) Pub. Date: Dec. 23, 2021

(54) SYSTEM AND METHOD FOR OPTIMIZING WRITE REQUESTS OF A WRITE QUEUE

(71) Applicant: RepliXio Ltd., Tel-Aviv (IL)

(72) Inventors: Avi SHILLO, Holon (IL); Cyril PLISKO, Petah-Tikva (IL); Andrey VESNOVATY, Holon (IL); Michael GREENBERG-SMIRNOFF, Tel Aviv (IL)

(73) Assignee: RepliXio Ltd., Tel-Aviv (IL)

(21) Appl. No.: 17/463,026

(22) Filed: Aug. 31, 2021

Related U.S. Application Data
(63) Continuation of application No. PCT/US2020/021713, filed on Mar. 9, 2020.
(60) Provisional application No. 62/816,620, filed on Mar. 11, 2019.

(51) Int. Cl. G06F 3/06

(52) U.S. Cl. CPC G06F 3/0659; G06F 3/0673; G06F 3/0604

(57) ABSTRACT

A system and method for optimizing write requests of a write queue, including: receiving a current write request for updating a storage, wherein the current write request includes at least data to be written to the storage and a location within the storage into which the data is to be written; determining if there is at least one overlap between the current write request and an earlier write request within a write queue; and updating at least one of the current write request and the earlier write request to eliminate the at least one overlap.

### CROSS-REFERENCE TO RELATED APPLICATIONS

This application is a continuation of International Patent Application No. PCT/US2020/021713 filed on Mar. 9, 2020, which claims the benefit of U.S. Provisional Application No. 62/816,620 filed on Mar. 11, 2019, the contents of which are hereby incorporated by reference.

### TECHNICAL FIELD

The present disclosure relates generally to data transfer and replication, and more particularly to efficient methods for such activity when handling write requests that include updated data stored in a write queue.

### BACKGROUND

In storage centers holding vast amounts of data, it is often necessary to ensure that data resides as close as possible to the relevant consumer. This allows for the data to be accessed, updated, or otherwise modified in the most efficient manner, both with regard to time as well as to network load. Working on live systems, i.e., systems that are not only configured to duplicate data, but also modify the data itself, provides a challenge to network devices configured to perform such data operations, such as routers, switches, and the like.

For example, there may be a need to transfer blocks of data from one location to another using a network device, where the device receives one or more write instructions. An update to some of the data blocks within the data being sent may have changed since the initial transfer request, and therefore an additional write request is sent to update the relevant data blocks. As a result, the network device will write the old, now outdated, data first and later rewrite that data with the new updates. While current solutions provide some efficiency by allowing for the merging of multiple writes to a single write, this does not resolve the problem identified by preventing unnecessary writes due to updated data. Thus, networks are often burdened with performing more data writes than is needed by including obsolete data when performing memory writes. This limits available bandwidth, especially in systems that are write intensive, and stresses both the network being used and the hardware executing the write commands, including hard drives, memory, and the like of servers or databases.

It should be noted that write queues used for these transactions may be large enough such that is may take time to accumulate all relevant changes, at which point new updates will render the old data obsolete.

It would therefore be advantageous to provide a solution for improvising the efficiency of handling of write requests.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for optimizing write requests of a write queue, including: receiving a current write request for updating a storage, wherein the current write request includes at least data to be written to the storage and a location within the storage into which the data is to be written; determining if there is at least one overlap between the current write request and an earlier write request within a write queue; and updating at least one of the current write request and the earlier write request to eliminate the at least one overlap.

Certain embodiments disclosed herein also include a non-transitory computer readable medium having stored thereon instructions for causing a processing circuitry to perform a process, the process including: receiving a current write request for updating a storage, wherein the current write request includes at least data to be written to the storage and a location within the storage into which the data is to be written; determining if there is at least one overlap between the current write request and an earlier write request within a write queue; and updating at least one of the current write request and the earlier write request to eliminate the at least one overlap.

Certain embodiments disclosed herein also include a system for optimizing write requests of a write queue, including: a processing circuitry; and a memory, the memory containing instructions that, when executed by the processing circuitry, configure the system to: receive a current write request for updating a storage, wherein the current write request includes at least data to be written to the storage and a location within the storage into which the data is to be written; determine if there is at least one overlap between the current write request and an earlier write request within a write queue; and update at least one of the current write request and the earlier write request to eliminate the at least one overlap.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network device according to an embodiment.

FIG. 2 is a schematic diagram of write requests that have overlap conditions according to an embodiment.

FIG. 3 is another schematic diagram of write requests that have overlap conditions according to a further embodiment.

FIG. 4 is a flowchart illustrating a method of a queue manager according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for merging and splitting data in a write queue of a network device, such as a router, a switch, a hub, and the like. Such a network device typically includes one or more network interfaces, a write queue, and a queue manager. The network device is used to efficiently provide data to relevant destinations, e.g., data centers where data is transferred or copied, continuously or periodically, from one data location to another.

In a live system, for example, it is possible that the data being transferred or copied changes over time, i.e., before the network device completes an original write transaction. To prevent unnecessary transfers and increase the efficiency of such a data system, a network device is configured to include the queue manager. The queue manager performs various merge and split operations to efficiently handle the write queue so that obsolete data is not sent over the network. As a result only updated and relevant data is transferred. This reduces the network load of the entire system, and reduces processing requirements of the network device, e.g., processing power and memory. The network device may be implemented as a standalone component, as a subsystem within a system, as a virtual device, on a cloud computing system, and the like.

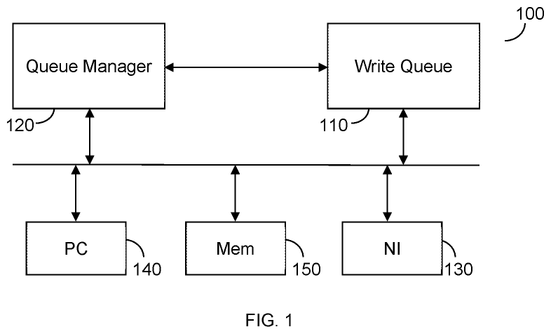

FIG. 1 is an example schematic block diagram of a network device 100 according to an embodiment. The network device 100 includes a queue manager 120 and a write queue 110, along with a processing circuitry 140, a memory 150, and one or more network interfaces 130. In an embodiment, the queue manager 120, the write queue 110, or both, are implemented as a hardware, a software configured to be executed by a hardware, or a combination thereof within the network device 100. In a further embodiment, the write queue 110 is a table or array stored within the network device 100, or otherwise a queue implemented in software or hardware or combination thereof, that includes a list of writes to be executed and the order in which they are executed. The hardware of the write queue may include hardware configured to receive and store a data flow.

The processing circuitry 140 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

In an embodiment, the memory 150 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 140 to perform the various processes described herein.

The write queue 110 is controlled by the queue manager 120, both of which are connected to each other as well as to at least one network interface 130 (for convenience only a single network interface is shown but this should not be considered limiting upon the generality of the invention).

The network interface 130 may provide an interface to different type of networks through different interface type. Examples for networks include a local area network (LAN), wide area network (WAN), metro area network (MAN), the Internet, the worldwide web (WWW), and any other network and combinations thereto, not shown, including a wired or wireless network.

The write queue 110 is loaded with commands and data for performing write requests to one or more destinations. This is performed under the control of the queue manager 120. In an embodiment, the queue manager 120 is metadata aware, and therefore can be configured to identify several different scenarios that require intervention in the stream of write commands that are in the write queue. A write request provided to the network device 100 includes at least the data to be written into a storage, the destination of the data, i.e., the particular storage, the length of the data and a timestamp. The timestamp allows for identifying which write request is an earlier or a later request.

It should be noted that the architecture of the network device 110 illustrated in FIG. 1 is not limiting architectures and/or configurations may be applicable. The network device 110 may be a physical device or a virtual device. The network device 110 may be a virtual or physical router, switch, hub, load balance, ADC, or any other device configured to transfer data over a network.

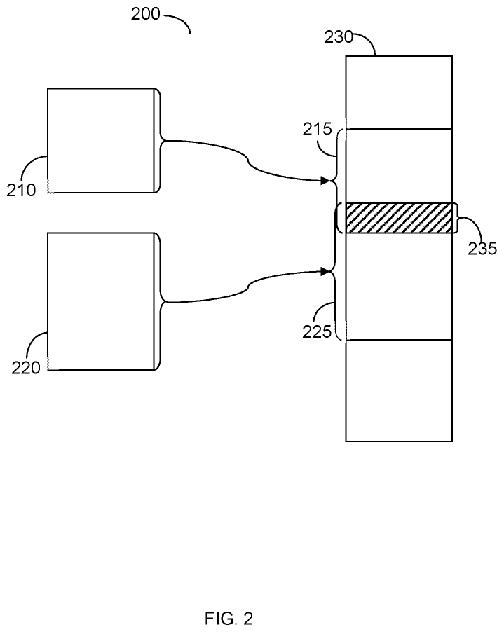

FIG. 2 is a schematic diagram 200 of write requests that have certain overlap conditions according to an embodiment. A first write request 210 is destined for storage 230. The storage 230 may be, but is not limited to, network storage, network-attached storage, block level storage devices, distributed storage, and the like, as well as any combinations thereof, includes one or more storage areas. Each storage area is a section within the storage 230 assigned to store a particular set of data. In the shown embodiment, the first write request 210 is sent to a first storage area 215. The storage 230 may be, but is not limited to, a network storage, a network-attached storage, block level storage devices, a distributed storage, and the like, as well as any combinations thereof.

A second write 220 request following thereafter and is destined for the same storage 230 at a second storage area 225. In the shown embodiment, there is an overlapping area 235 between the two writes, rendering a portion of the first write request 210 to not accurately reflect the current state of the sending memory, i.e., that memory from which data is to be replicated or transferred.

According to an embodiment, the queue manager (110, FIG. 1) may assess this situation based on, for example, one or more predetermined rules using soft or hardwired logic, machine learning techniques, or any other available solutions, for the purpose of determining how best to treat each particular scenario.

In a further embodiment, the machine learning techniques may include implementation of one or more neural networks, recurrent neural networks, decision tree learning, Bayesian networks, clustering, and the like. It should be noted that different parameters represented by the set of data from the first or second write requests may be analyzed using different machine learning techniques.

An optimal type of action for updated the first write request, the second write request, or both, is determined. One possibility is merging the two write requests into a single write requests in such a way that the overlapping data will only be supplied from the second write request. Another possibility is to update the first write request to perform the write only up to the overlap area and leave the second write request untouched as it will perform the write request as needed. Yet another possibility is creating three write requests, one for each of the non-overlapping write requests and one for the overlapping write request, and causing the sending of that write closer in time to the writing of the first write request to its destination. Yet another option based on the immediately previous one is merging the overlapping data with the first write request and updating the second write request so that it does not include the overlap data.

Each option may have distinct merits depending on the load on the network device 100, the bandwidth of the network interface 130, and other parameters that may be provided as metadata to the queue manager 130 and that may be taken into account when issuing the updated write requests.

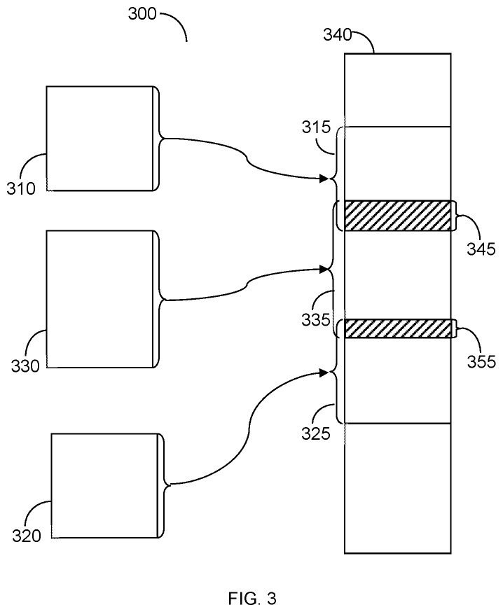

FIG. 3 is a second schematic diagram 200 of write requests that have certain overlap conditions. In this case a first write request 310 attempts to write data into a storage 340 at location 315, a second write request 320 attempts to write data into the storage 340 at location 325, and a third write request attempts 330 to write data into the storage 340 at location 335. The storage 340 may be, but is not limited to, network storage, network-attached storage, block level storage devices, distributed storage, and the like, as well as any combinations thereof.

The first write request 310 and the second write request 320 have no overlap in their intended locations 315 and 325, respectively; however, the third write request 330 overlaps both the first write request 310 at location 345, and the second write request 320 at location 355. Similar to the case discussed above with respect of FIG. 2, there are several ways to address this matter. For example, a first option would be to replace the three write requests by a single write request that merges the three write requests and ensures that the areas of overlap are taken from the third write request. A second option includes generating five different write requests, one for each of the first, second and third write requests for the data that has no overlap, and one for each of the two overlap areas. These are exemplary approaches, and other combinations may be possible.

For yet another example it may be desirable to generate two new write requests one that merges the first and third write requests so that the overlap area between the first and their write request is taken from the third write request, and the overlap data between the third and second write request is merged with the second write request so that this area of overlap is provided from the third write request. The result would be two write requests.

While two examples of potential overlaps have been shown in FIGS. 2 and 3, it should be noted that other examples, some having higher degrees of complexity, e.g., managing more than three write requests, receiving write requests for storing data across multiple storages, e.g., a distributed file system, receiving write requests from multiple sources, and the like, may exist without departing from the principles of the disclosure described here. In an embodiment, the queue manager 120 or the processing circuitry 140 of the network device 100 discussed in FIG. 1 is configured to make the necessary changes to the write requests to most efficiently recreate the write requests in such a way that the most current data is written to the storage while making optimal use of various components of the network device 100, including, but not limited to, the memory 150 and the one or more network interfaces 130.

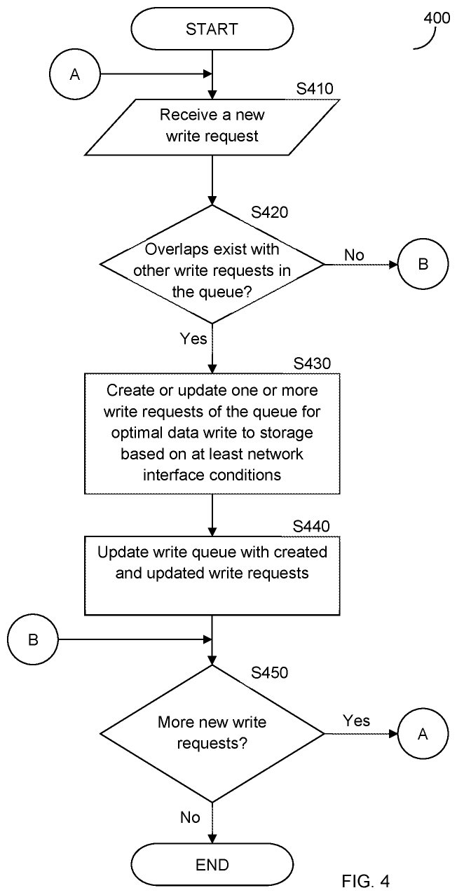

FIG. 4 is an example flowchart 400 illustrating a method for optimizing write requests of a write queue according to an embodiment.

At S410, a new write request including an update to be written to a storage is received, e.g., by a network device. The new write request is provided to a write queue and a queue manager, each receiving the respective information relevant to its operation. In an embodiment, the write queue is configured to store the data to be written, and the queue manager is configured to determine the order in which the queued write requests are executed, e.g., based on timestamps associated with each write request.

At S420, it is determined whether there is an overlap between the new write request and any earlier write requests previously received which still reside within the write queue 110. If an overlap is detected, execution continues at S430; otherwise, execution continues at S450. The detection of the overlap is achieved by comparing the addresses to which data is to be written within the storage, as well as the amount of data that is to be written. Therefrom, it is possible to determine if there is an overlap between two different write requests.

At S440, a determination is made with respect to the type of action required as a result of the detected overlap. An overlap may be partial, as discussed above with respect of FIGS. 2 and 3, or complete, in which case the earlier write request can be completely discarded. In the case of a partial overlap and based on one or more heuristics available to the queue manager, for example one or more predetermined rules, a learning machine employing predetermined heuristics, hard or soft logic having a predetermined heuristics and the like, a determination is made as to the action necessary that may include but is not limited to.

It should be noted that such heuristics typically pertain to trial-and-error methods to problem solving. Such approaches are useful when an algorithmic approach is impractical or otherwise overly costly to implement. By implementing heuristics that may include, e.g., the self-learning of solutions that provide better performance of the queue, the overall performance of the system is improved when encountering similar cases in the future. The type of action may include discarding of a write request, fully merging write requests, partially merging write requests, and creating new write requests.

In an embodiment, the determination is made so that an optimal use of hardware, including a network interface, a network device memory, and the like, is achieved in terms of speed and bandwidth. Further, metadata, including a timestamp for each of the write requests, may be used to ensure the ability to distinguish between earlier and later write requests. At S440, any newly created write requests are loaded into the write queue for future execution.

At S450, it is checked whether additional write requests have been received and if so execution continues at S410; otherwise, execution terminates.

It should be appreciated that the disclosed embodiments allow receiving a write request for update of a storage, the write request includes at least data to be written to the storage, an address of the storage, a location within the storage into which the data is to be written into, and size of the data; checking whether there is at least one overlap area when writing the data to be written to the storage and any previous data to be written into the storage that is already in the write queue; and changing at least one of the received write request and write requests currently in the write queue such that only a most update data is written into the at least one overlap area.

In another embodiments, the disclosed embodiments provides for a network device that includes of one or more network interfaces; a write queue adapted to receive a plurality of write requests, each write request includes data to be used, destination of the data, length of the data and a timestamp; and a queue manager adapted to determine based on the received write request cases of overlap between write requests currently being processed by the network device, such that optimized use of at least the one or more network interfaces is achieved. Such optimized use may include, for example, prevention or attempts to refrain from writing data to a storage when it is already determined that such data will be overwritten momentarily by an updated data.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for optimizing write requests of a write queue, comprising:
receiving a current write request for updating a storage, wherein the current write request includes at least data to be written to the storage and a location within the storage into which the data is to be written;
determining if there is at least one overlap between the current write request and an earlier write request within a write queue; and
updating at least one of the current write request and the earlier write request to eliminate the at least one overlap.

2. The method of claim 1, further comprising:
determining an order in which the current write request and the earlier write request are to be executed.

3. The method of claim 1, wherein the current write request further includes an address of the storage and a size of the data to be written to the storage.

4. The method of claim 1, further comprising:
determining an optimal type of action based on the at least one overlap; and
updating at least one of the current write request and the earlier write request based on the determined optimal type of action.

5. The method of claim 4, wherein the optimal type of action includes:
merging the current write request and the earlier write request into a single write request.

6. The method of claim 4, wherein the optimal type of action includes updating the current write request to perform a write until the at least one overlap without modifying the earlier write request.

7. The method of claim 4, wherein the optimal type of action includes creating three new write requests, including one for each non-overlapping section of the current write request and the earlier write request and one for an overlapping section of the current write request and the earlier write request.

8. The method of claim 4, wherein the optimal type of action is determined based on machine learning techniques that include implementation of at least one of: a neural network, a recurrent neural network, a decision tree learning, a Bayesian network, and clustering.

9. The method of claim 1, wherein determining if there is at least one overlap between the current write request and an earlier write request within a write queue is implemented using predetermined heuristics.

10. A non-transitory computer readable medium having stored thereon instructions for causing a processing circuitry to perform a process, the process comprising:
receiving a current write request for updating a storage, wherein the current write request includes at least data to be written to the storage and a location within the storage into which the data is to be written;
determining if there is at least one overlap between the current write request and an earlier write request within a write queue; and
updating at least one of the current write request and the earlier write request to eliminate the at least one overlap.

11. A system for optimizing write requests of a write queue, comprising:
a processing circuitry; and
a memory, the memory containing instructions that, when executed by the processing circuitry, configure the system to:
receive a current write request for updating a storage, wherein the current write request includes at least data to be written to the storage and a location within the storage into which the data is to be written;
determine if there is at least one overlap between the current write request and an earlier write request within a write queue; and
update at least one of the current write request and the earlier write request to eliminate the at least one overlap.

12. The system of claim 11, wherein the system if further configured to:
determine an order in which the current write request and the earlier write request are to be executed.

13. The system of claim 11, wherein the current write request further includes an address of the storage and a size of the data to be written to the storage.

14. The system of claim 11, wherein the system if further configured to:
determine an optimal type of action based on the at least one overlap; and
update at least one of the current write request and the earlier write request based on the determined optimal type of action.

15. The system of claim 14, wherein the optimal type of action includes:
merging the current write request and the earlier write request into a single write request.

16. The system of claim 14, wherein the optimal type of action includes updating the current write request to perform a write until the at least one overlap without modifying the earlier write request.

17. The system of claim 14, wherein the optimal type of action includes creating three new write requests, including one for each non-overlapping section of the current write request and the earlier write request and one for an overlapping section of the current write request and the earlier write request.

18. The system of claim 14, wherein the optimal type of action is determined based on machine learning techniques that include implementation of at least one of: a neural network, a recurrent neural network, a decision tree learning, a Bayesian network, and clustering.

19. The system of claim 11, wherein determining if there is at least one overlap between the current write request and an earlier write request within a write queue is implemented using predetermined heuristics.
